(19) United States
(12) Patent Application Publication
(10) Pub. No.: US 2026/0029702 A1
(43) Pub. Date: Jan. 29, 2026

(54) VEHICLE PROJECTOR

(71) Applicant: SL Corporation, Daegu (KR)

(72) Inventors: Jong Woon KIM, Gyeongsan-si (KR); Chang Ho RYU, Gyeongsan-si (KR)

(21) Appl. No.: 19/217,620

(22) Filed: May 23, 2025

(30) Foreign Application Priority Data
Jul. 26, 2024 (KR) 10-2024-0099170

(51) Int. Cl. G03B 21/20; B60Q 1/50; G03B 21/14; G03B 21/28

(52) U.S. Cl. CPC G03B 21/2046; B60Q 1/50; G03B 21/147; G03B 21/28; B60Q 2400/50

(57) ABSTRACT

A vehicle projector includes: a light-emitting unit that emits light for image formation; an optical unit including at least one optical lens arranged along a reference axis in a path of the light emitted from the light-emitting unit; a reflective unit that is disposed on a first side with respect to the reference axis and reflects the light emitted from the optical unit in a direction intersecting the reference axis to allow the light to be directed onto a projection surface; and an optical path adjustment unit that is disposed on a second side with respect to the reference axis and adjusts the path of the light emitted from the optical unit toward the reflective unit.

### CROSS-REFERENCE TO RELATED APPLICATION

This application claims priority from Korean Patent Application No. 10-2024-0099170 filed on Jul. 26, 2024, which is incorporated herein by reference in its entirety.

### BACKGROUND

### 1. Technical Field

The present disclosure relates to a vehicle projector and, more specifically, to a vehicle projector that projects an image for displaying information inside or outside a vehicle.

### 2. Description of the Related Art

Vehicles are equipped with head-up displays, instrument panels, and the like to provide various information to passengers inside the vehicles. Additionally, projectors are installed to project images onto the road surfaces around the vehicles or onto the vehicles' glass to provide various information to surrounding vehicles or pedestrians.

Meanwhile, projectors require a sufficient projection distance to project an image of adequate size onto the projection surfaces. This makes it challenging to form sufficiently large images on the road surfaces around the vehicles or on the vehicles' glass. To address this issue, research is actively being conducted on ultra-short throw projectors that can project sufficiently large images while maintaining a relatively short projection distance between the projectors and the projection surfaces.

### SUMMARY

An object of the present disclosure is to provide a vehicle projector that reduces the space required for installing a projector for image projection.

The objects of the present disclosure are not limited to those mentioned above, and other objects not explicitly stated will be clearly understood by those skilled in the art based on the following description.

According to an aspect of the present disclosure, a vehicle projector may include a light-emitting unit that emits light for image formation; an optical unit including at least one optical lens arranged along a reference axis in a path of the light emitted from the light-emitting unit; a reflective unit that is disposed on a first side with respect to the reference axis and reflects the light emitted from the optical unit in a direction intersecting the reference axis to allow the light to be directed onto a projection surface; and an optical path adjustment unit that is disposed on a second side with respect to the reference axis and adjusts the path of the light emitted from the optical unit toward the reflective unit.

The reflective unit may be disposed across from the projection surface with respect to the reference axis, and the optical path adjustment unit may be disposed in a side closer to the projection surface with respect to the reference axis.

The reference axis may be aligned substantially parallel to the projection surface.

The optical unit may include a first lens group configured to correct chromatic aberration of the light emitted from the light-emitting unit; and a second lens group configured to diffuse the light emitted from the light-emitting unit.

The at least one optical lens may include a plurality of optical lenses arranged along the reference axis, and the plurality of optical lenses may include at least one cut lens disposed at a final stage along the path of the light emitted from the light-emitting unit.

Each of the plurality of optical lenses may include a first region, which is disposed at a side where the reflective unit is disposed with respect to the reference axis, and a second region, which is disposed at a side where the optical path adjustment unit is disposed with respect to the reference axis. The at least one cut lens may be formed by cutting a portion of the first region. Light incident on the optical unit may be emitted through a region disposed at the side where the optical path adjustment unit is disposed with respect to a cut surface of the at least one cut lens. A region of the light-emitting unit where light is emitted may be disposed at the side where the reflective unit is disposed with respect to the reference axis, and light incident on the optical unit from the light-emitting unit may be emitted through the second region of the at least one cut lens.

A rear end of the reflective unit may be disposed to at least partially overlap with a cut surface of the at least one cut lens in a front-rear direction.

The optical path adjustment unit may be disposed to allow light reflected toward the reflective unit to proceed through a region in front of a cut surface of the at least one cut lens.

The reflective unit and the optical path adjustment unit may be disposed to allow light sequentially reflected by the optical path adjustment unit and the reflective unit to proceed through a region in front of a front end of the optical path adjustment unit.

The optical path adjustment unit may be inclined such that a rear end thereof is spaced radially farther apart from the reference axis than a front end thereof.

The optical path adjustment unit may be disposed such that both of a front end thereof and a rear end thereof are spaced radially apart from the reference axis.

The optical path adjustment unit may be inclined with respect to the reference axis by an inclination angle of about 45 degrees.

The vehicle projector according to the present disclosure may have one or more of the following effects.

Since the light-emitting unit and the optical unit are arranged along a reference axis parallel to the projection surface, and the reflective unit and the optical path adjustment unit are arranged in a direction intersecting the reference axis, the installation space in the direction intersecting the reference axis can be reduced.

Additionally, since the rear end of the reflective unit is disposed to overlap with at least one cut lens disposed at the final stage of the optical unit, the installation space in the direction of the reference axis can also be reduced.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a schematic view illustrating an image projected by a projector installed in a vehicle according to an embodiment of the present disclosure;

FIG. 2 is a perspective view illustrating a vehicle projector according to an embodiment of the present disclosure;

FIG. 3 is a plan view illustrating the vehicle projector according to an embodiment of the present disclosure;

FIG. 4 is a bottom view illustrating a vehicle projector according to an embodiment of the present disclosure;

FIG. 5 is a cross-sectional view taken along line A-A′ of FIG. 3;

FIG. 6 is a front view illustrating a first cut lens according to an embodiment of the present disclosure;

FIG. 7 is a front view illustrating a second cut lens according to an embodiment of the present disclosure;

FIG. 8 is a schematic view illustrating the optical path of the vehicle projector according to an embodiment of the present disclosure;

FIG. 9 is a schematic view illustrating the path of light emitted from the vehicle projector according to an embodiment of the present disclosure;

FIG. 10 is a schematic view illustrating the installation space of the vehicle projector according to an embodiment of the present disclosure;

FIGS. 11 and 12 are schematic views illustrating a reference axis corresponding to the inclination angle of an optical path adjustment unit according to an embodiment of the present disclosure; and

FIG. 13 is a schematic view illustrating the path of light reflected by the optical path adjustment unit and a reflective unit according to an embodiment of the present disclosure.

### DETAILED DESCRIPTION

Advantages and features of the present disclosure and methods of accomplishing the same may be understood more readily by referring to the following detailed description of exemplary embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims. Throughout the specification, like reference numerals in the drawings denote like elements.

In some embodiments, well-known steps, structures and techniques will not be described in detail to avoid obscuring the disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Embodiments of the disclosure are described herein with reference to plan and cross-section illustrations that are schematic illustrations of exemplary embodiments of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing. In the drawings, respective components may be enlarged or reduced in size for convenience of explanation.

A vehicle projector according to an embodiment of the present disclosure will hereinafter be described with reference to the accompanying drawings.

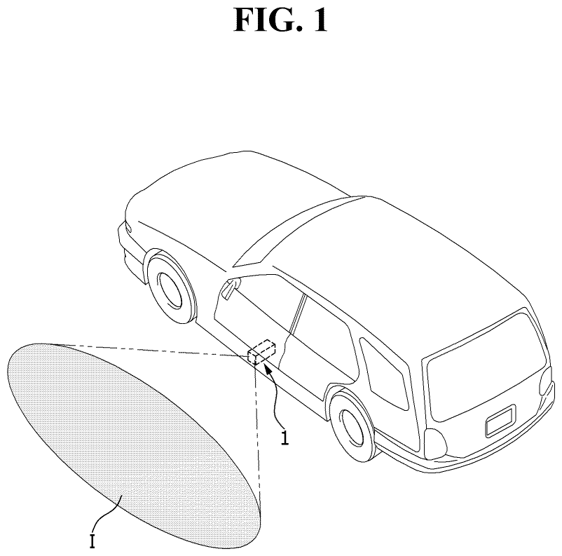

FIG. 1 is a schematic view illustrating an image projected by a projector installed in a vehicle according to an embodiment of the present disclosure.

Referring to FIG. 1, a vehicle projector 1 according to an embodiment of the present disclosure may be installed on the rocker panel of a vehicle and may project an image I onto the road surface on the side of the vehicle to provide information to the drivers of surrounding vehicles or to pedestrians.

In FIG. 1, the road surface around the vehicle is exemplified as the projection surface onto which the image I is projected by the vehicle projector 1, but the present disclosure is not limited thereto. The projection surface of the image I may be any surfaces disposed inside or outside the vehicle where the image I can be projected by the vehicle projector 1, such as the glass (e.g., windshield and window panels) of the vehicle as well as the road surface around the vehicle.

Furthermore, the vehicle projector 1 is exemplified as being installed on the rocker panel, but the present disclosure is not limited thereto. The installation position and direction of the vehicle projector 1 may vary depending on the position of the projection surface of the image I.

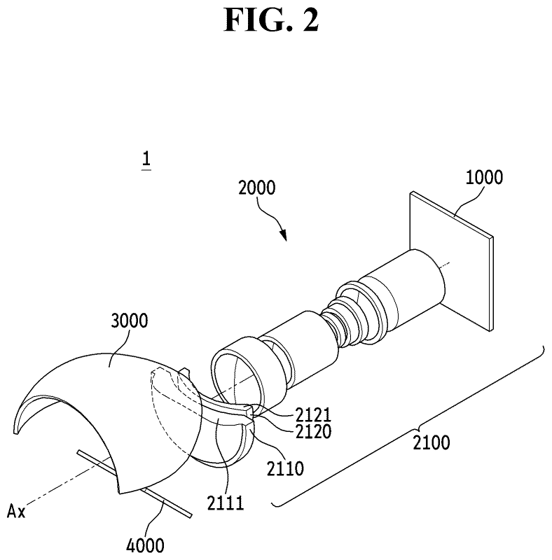

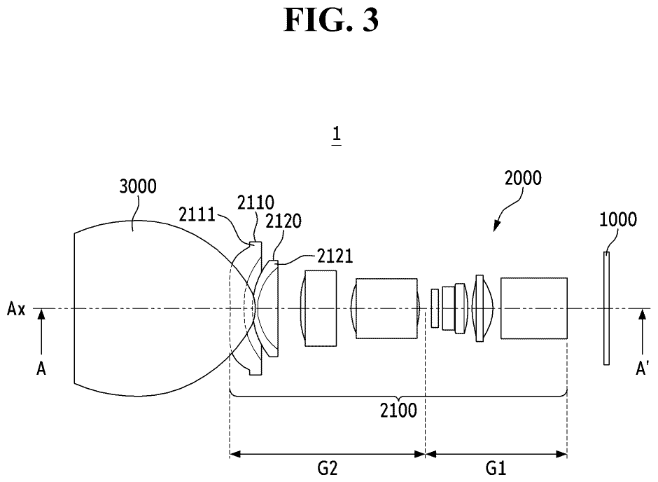

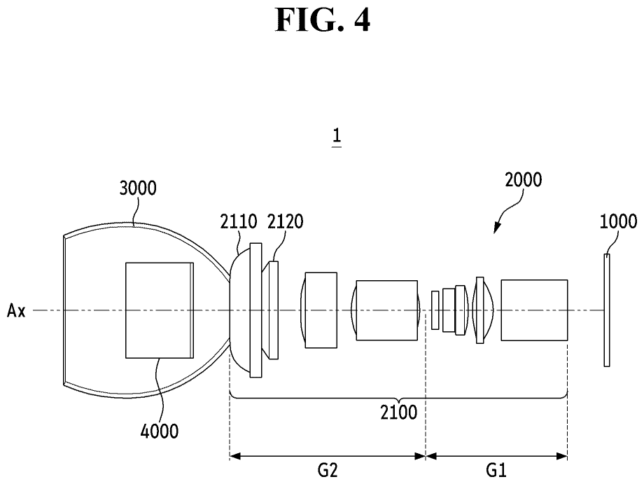

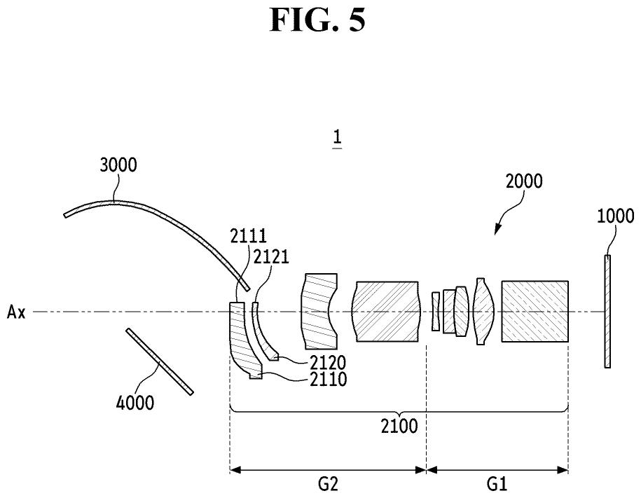

FIG. 2 is a perspective view illustrating a vehicle projector according to an embodiment of the present disclosure, FIG. 3 is a plan view illustrating the vehicle projector according to an embodiment of the present disclosure, FIG. 4 is a bottom view illustrating the vehicle projector according to an embodiment of the present disclosure, and FIG. 5 is a cross-sectional view taken along line A-A′ of FIG. 3.

Referring to FIGS. 2 through 5, the vehicle projector 1 may include a light-emitting unit 1000, an optical unit 2000, a reflective unit 3000, and an optical path adjustment unit 4000.

The light-emitting unit 1000 may emit light to form an image representing information that is desired to be provided to surrounding vehicles or pedestrians. A device such as a digital micromirror device (DMD) or liquid crystal on silicon (LCos), which emits light to form text, patterns, or images, may be used as the light-emitting unit 1000.

The optical unit 2000 may be disposed in front of the light-emitting unit 1000 and may serve to guide the light emitted from the light-emitting unit 1000 along a predetermined path. The placement of the optical unit 2000 in front of the light-emitting unit 1000 is based on the assumption that the direction in which the light is emitted from the light-emitting unit 1000 is the forward direction. However, depending on the installation position or direction of the vehicle projector 1, the actual meaning of “front” and “forward” may vary.

The optical unit 2000 may include at least one optical lens 2100 arranged along a reference axis (e.g., optical axis) Ax in the path of the light emitted from the light-emitting unit 1000. The optical unit 2000 will hereinafter be described as including a plurality of optical lenses 2100 arranged along the reference axis Ax, which serves as their central axis.

Here, each of the plurality of optical lenses 2100 may have at least one of light-incident surface or light-emitting surface thereof formed in a planar shape, a curved shape, or a combination thereof, depending on the path of the light emitted from the light-emitting unit 1000. Additionally, the plurality of optical lenses 2100 may have a convex shape, a concave shape, or a combination thereof depending on the convergence or divergence of the light.

The optical unit 2000 may include a first lens group G1 for chromatic aberration correction and a second lens group G2 for diffusion, with the second lens group G2 being disposed in front of the first lens group G1 along the reference axis Ax. However, the present disclosure is not limited thereto. The number, positions, and roles of the lens groups of the optical unit 2000 may vary depending on the attributes of the image to be formed by the vehicle projector 1, such as position, size, or clarity.

The plurality of optical lenses 2100 may include one or more cut lenses 2110 and 2120 disposed at the final stage along the path of light emitted from the light-emitting unit 1000. The positioning of the cut lenses 2110 and 2120 at the final stage means that the light is emitted from the optical unit 2000 through the cut lenses 2110 and 2120.

The cut lenses 2110 and 2120 may include a first cut lens 2110 disposed at the final stage among the plurality of optical lenses 2100 along the reference axis Ax and a second cut lens 2120 disposed before the first cut lens 2110. However, the present disclosure is not limited thereto. Alternatively, the optical unit 2000 may include a single cut lens at the final stage among the plurality of optical lenses 2100 or may include more than two cut lenses disposed adjacent to one another at the final stage among the plurality of optical lenses 2100.

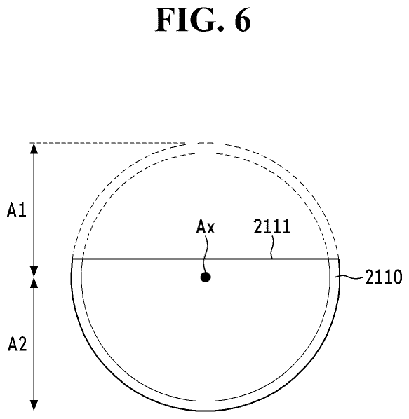

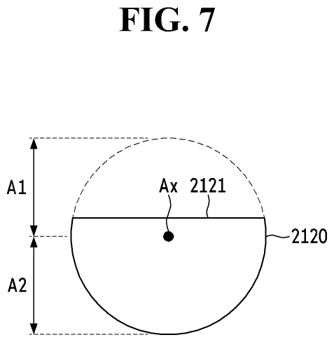

FIG. 6 is a front view illustrating a first cut lens according to an embodiment of the present disclosure, and FIG. 7 is a front view illustrating a second cut lens according to an embodiment of the present disclosure.

Referring to FIG. 6, the first cut lens 2110, which is an optical lens disposed at the final stage among the plurality of optical lenses 2100 along the path of light emitted from the light-emitting unit 1000, may be divided into a first region A1 and a second region A2. The first region A1 may be disposed in the direction where the reflective unit 3000 is disposed, and the second region A2 may be disposed in the direction where the optical path adjustment unit 4000 is disposed, with respect to the reference axis Ax. A portion of the first region A1 may be cut off, such that a cut surface 2111 is formed at the side where the reflective unit 3000 is disposed with respect to the reference axis Ax.

Referring to FIG. 7, similar to the first cut lens 2110, the second cut lens 2120, which is an optical lens disposed before the first cut lens 2110 along the path of light emitted from the light-emitting unit 1000, may be divided into a first region A1 and a second region A2 with respect to the reference axis Ax. A portion of the first region A1 may be cut off, such that a cut surface 2121 is formed at the side where the reflective unit 3000 is disposed with respect to the reference axis Ax.

The optical unit 2000 has been described as including two cut lenses 2110 and 2120 disposed consecutively at the final stage among the plurality of optical lenses 2100, but the present disclosure is not limited thereto. The number of cut lenses may vary depending on the path of light that passes through each of the plurality of optical lenses 2100.

Meanwhile, as illustrated in FIGS. 6 and 7, each of the cut lenses 2110 and 2120 may be formed by cutting off a portion of the first region A1, which is closer to the reflective unit 3000 with respect to the reference axis Ax. Due to the cutting, the rear end of the reflective unit 3000 may be disposed to overlap the cut surfaces 2111 and 2121 of the cut lenses 2110 and 2120 at least partially in a front-rear (e.g., longitudinal or axial) direction, as illustrated in FIGS. 3 through 5. Consequently, the space occupied by the vehicle projector 1 in the direction of the reference axis Ax can be reduced.

In FIGS. 6 and 7, each of the cut lenses 2110 and 2120 is illustrated as being divided into the first and second regions A1 and A2, but the present disclosure is not limited thereto. The other optical lenses 2100 may also be divided into the first and second regions A1 and A2 with respect to the reference axis Ax, regardless of whether they are cut or uncut.

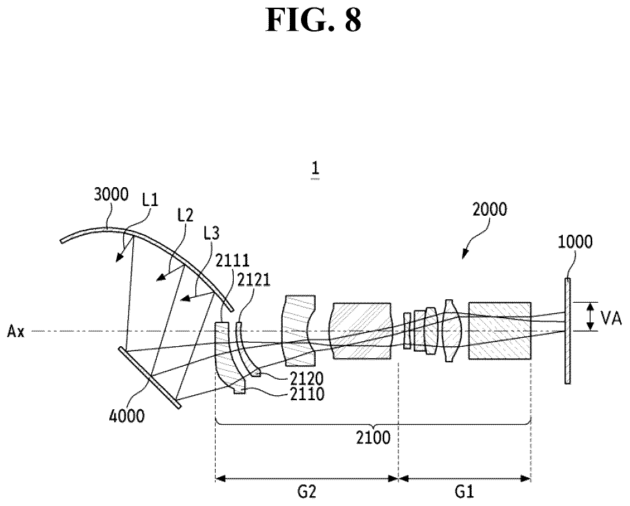

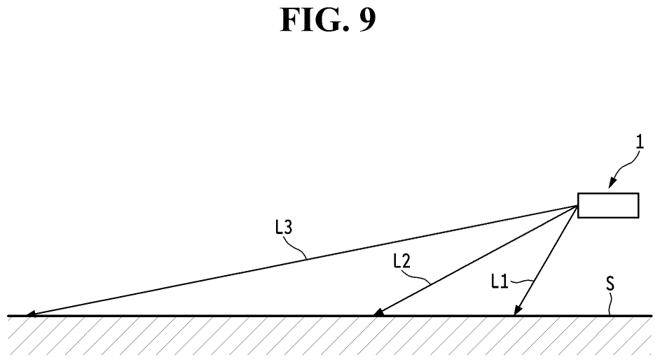

FIG. 8 is a schematic view illustrating the optical path of the vehicle projector according to an embodiment of the present disclosure, and FIG. 9 is a schematic view illustrating the path of light emitted from the vehicle projector according to an embodiment of the present disclosure.

Referring to FIGS. 8 and 9, light L1, L2, and L3 emitted from the light-emitting unit 1000 may pass through the optical unit 2000, may be output from the cut lenses 2110 and 2120 included at the final stage of the optical unit 2000, and may then proceed to the optical path adjustment unit 4000. Subsequently, upon being reflected by the optical path adjustment unit 4000 toward the reflective unit 3000, the light L1, L2, and L3 may be directed onto different positions on a projection surface S by the reflective unit 3000.

Since the light L1, L2, and L3 that passes through the cut lenses 2110 and 2120 proceeds through the side where the optical path adjustment unit 4000 is disposed with respect to the reference axis Ax, the cut portions of the first regions A1 of the cut lenses 2110 and 2120, which are formed in the side where the reflective unit 3000 is disposed, may not affect the path of the light L1, L2, and L3.

Furthermore, an emission area VA, where the light is actually emitted from the light-emitting unit 1000, may be formed in the side where the reflective unit 3000 is disposed with respect to the reference axis Ax. As previously described, this configuration ensures that the light emitted from the light-emitting unit 1000 is projected through the cut lenses 2110 and 2120 via the side where the optical path adjustment unit 4000 is disposed with respect to the reference axis Ax.

The emission area VA may be formed in a portion of the light-emitting unit 1000 and may be disposed in the side where the reflective unit 3000 is disposed with respect to the reference axis Ax (i.e., the upper half in the orientation shown in this embodiment), but the present disclosure is not limited thereto. The emission area VA may be formed in at least a portion of the light-emitting unit 1000, or the entire light-emitting unit 1000 may be disposed in the side where the reflective unit 3000 is disposed with respect to the reference axis Ax.

Generally, images formed by the light that passes through a lens are inverted due to refraction. Accordingly, when the emission area VA is disposed in the side where the reflective unit 3000 is disposed with respect to the reference axis Ax, the light passes through the cut lenses 2110 and 2120 through the region in the side where the optical path adjustment unit 4000 is disposed with respect to the reference axis Ax. This configuration allows the rear end of the reflective unit 3000 to at least partially overlap the cut surfaces 2111 and 2121 of the cut lenses 2110 and 2120 in the front-rear direction.

Meanwhile, even though the region where the light passes through the cut lenses 2110 and 2120 is disposed in the side with respect to the reference axis Ax where the optical path adjustment unit 4000 is disposed, the cut surfaces 2111 and 2121 may also be disposed apart from the reference axis Ax toward the side where the reflective unit 3000 is disposed. This configuration is to ensure that the plurality of optical lenses 2100 may be aligned with one another more easily based on their central axes. Aligning the plurality of optical lenses 2100 based on their respective central axes may mean that when arranged along the reference axis Ax, the plurality of optical lenses 2100 may be aligned with one another based on their respective central axes.

Additionally, the cut surfaces 2111 and 2121 may be disposed apart from the reference axis Ax in the direction opposite to the region where the light passes through the cut lenses 2110 and 2120, to ensure that the cut lenses 2110 and 2120 are not excessively cut. If the cut lenses 2110 and 2120 are excessively cut, the central portions of the cut lenses 2110 and 2120, where the light intensity is relatively high, may be removed, leading to a reduction in light intensity.

In other words, depending on the positions of the cut surfaces 2111 and 2121, they may not be disposed overlapping with the rear end of the reflective unit 3000, leading to an increase in size in the front-rear direction, or fail to provide a sufficient light intensity. Thus, the positions of the cut surfaces 2111 and 2121 may be determined in consideration of both size constraints and light intensity reduction.

The optical unit 2000 has been described as including a plurality of optical lenses 2100 that adjust the path of light through refraction, but the present disclosure is not limited thereto. The optical unit 2000 may also include other optical elements that adjust the path of light through reflection, such as mirrors, prisms, and reflectors, in addition to the plurality of optical lenses 2100.

The reflective unit 3000 may be disposed on one side with respect to the reference axis Ax and may serve to reflect the light emitted from the optical unit 2000 onto the projection surface S, as illustrated in FIGS. 8 and 9. The reflective unit 3000 may have an aspherical or freeform surface so that the light reflected off of different points on the reflective unit 3000 may be directed to different distances from the vehicle projector 1.

The reflective unit 3000 may be disposed in the side opposite to the projection surface S with respect to the reference axis Ax, thereby allowing the light emitted from the optical unit 2000 to be reflected toward the projection surface S.

The optical path adjustment unit 4000 may be disposed on the side opposite from the optical unit 2000 with respect to the reference axis Ax and may reflect the light emitted from the optical unit 2000 toward the reflective unit 3000. To achieve this, the optical path adjustment unit 4000 may be inclined such that a rear end thereof is radially farther from the reference axis Ax than a front end thereof.

The light emitted from the optical unit 2000 may be configured to proceed toward the reflective unit 3000 via the optical path adjustment unit 4000 to ensure that the vehicle projector 1 occupies less space in the direction perpendicular to the projection surface S.

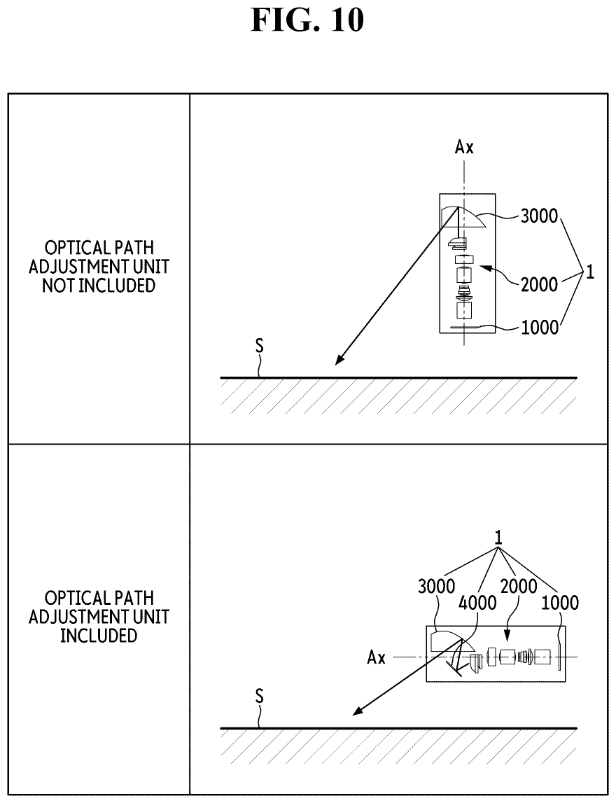

That is, as illustrated in FIG. 10, when the optical path adjustment unit 4000 is omitted (as shown in the top panel), the plurality of optical lenses 2100 of the optical unit 2000 may be arranged along the reference axis Ax, which is perpendicular to the projection surface S. In this case, the reflective unit 3000 may also be disposed at the rear end of the optical unit 2000 along the direction in which the light is emitted from the light-emitting unit 1000. This configuration increases the space occupied in the direction perpendicular to the projection surface S. However, when the light emitted from the optical unit 2000 is reflected by the optical path adjustment unit 4000 toward the reflective unit 3000 (as shown in the bottom panel), the space occupied in the direction perpendicular to the projection surface S may be decreased. As a result, the vehicle projector 1 can be installed even in a location with limited vertical installation space, such as a rocker panel.

Meanwhile, the optical path adjustment unit 4000 may be disposed, for example, at an inclination angle of about 45 degrees with respect to the reference axis Ax. This is because, when the optical path adjustment unit 4000 is inclined at about 45 degrees, the reference axis Ax may be disposed substantially parallel to the projection surface S, thereby reducing the space occupied in the direction perpendicular to the reference axis Ax by the vehicle projector 1. In other words, with regards to the orientation shown in the present disclosure, the vertical height of the vehicle projector 1 may be decreased.

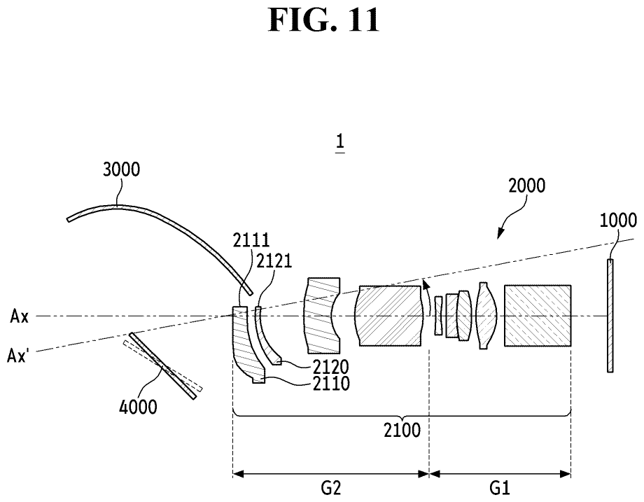

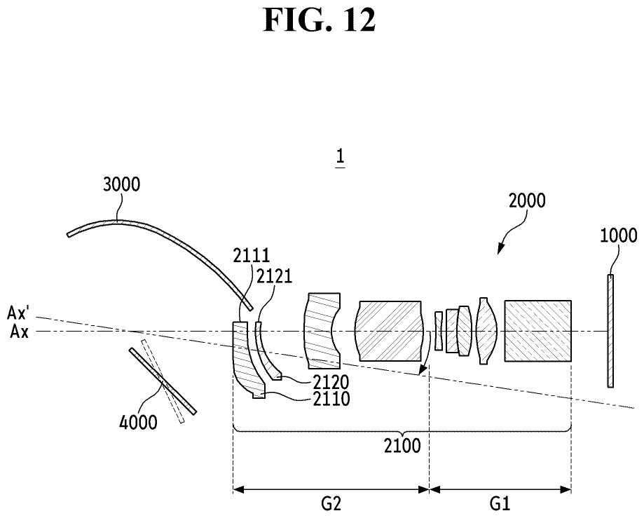

For example, when the optical path adjustment unit 4000 has an inclination angle greater or less than 45 degrees, the reference axis Ax may not be parallel to the projection surface S. In this case, as illustrated in FIGS. 11 and 12, the plurality of optical lenses 2100 of the optical unit 2000 may be arranged along a reference axis Ax′ that is tilted at a certain angle upward or downward with respect to the projection surface S. Consequently, the space occupied in the direction perpendicular to the projection surface S by the vehicle projector 1 may increase.

However, the inclination angle of the optical path adjustment unit 4000 is not limited to 45 degrees. The inclination angle of the optical path adjustment unit 4000 may be greater or less than 45 degrees depending on the installation space available for the vehicle projector 1.

Meanwhile, not only the rear end but also the front end of the optical path adjustment unit 4000 may be spaced apart from the reference axis Ax by a predetermined distance. This is to prevent interference with the light reflected by the reflective unit 3000.

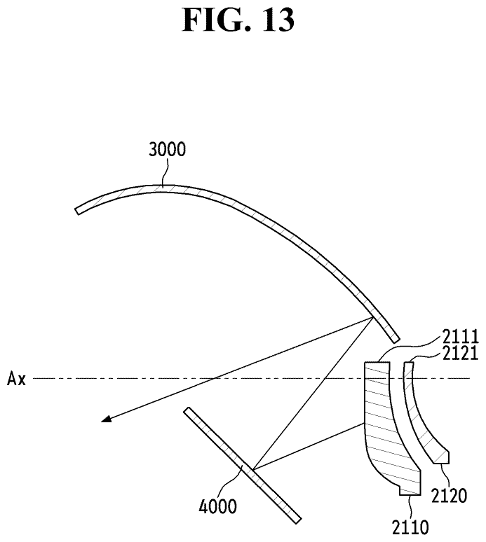

That is, as illustrated in FIG. 13, the light emitted through the cut lenses 2110 and 2120 of the optical unit 2000 may be reflected by the optical path adjustment unit 4000 toward the reflective unit 3000 and then directed toward the projection surface S. In this case, the optical path adjustment unit 4000 may need to be disposed such that the light reflected by the reflective unit 3000 may proceed through the region in front of the cut surfaces 2111 and 2121 of the cut lenses 2110 and 2120. This ensures that no optical interference occurs between the optical path adjustment unit 4000 and the cut lenses 2110 and 2120.

Furthermore, the reflective unit 3000 and the optical path adjustment unit 4000 may be disposed such that the light reflected by the reflective unit 3000 toward the projection surface S may proceed through the region in front of the front end of the optical path adjustment unit 4000.

The optical path adjustment unit 4000 has been described as including a mirror that reflects light, but the present disclosure is not limited thereto. The optical path adjustment unit 4000 may include various types of optical elements, such as a lens or a light guide, that adjust the path of light by reflection and/or refraction, in addition to a mirror.

As described above, in the vehicle projector 1, the reflective unit 3000 and the optical path adjustment unit 4000 may be disposed on opposite sides with respect to the reference axis Ax, and the light emitted from the optical unit 2000 may be reflected by the optical path adjustment unit 4000 toward the reflective unit 3000 before proceeding to the projection surface S. As a result, the space occupied by the vehicle projector 1 in the direction perpendicular to the projection surface S can be reduced.

Additionally, since the cut lenses 2110 and 2120 are included at the final stage among the plurality of optical lenses 2100 of the optical unit 2000, the rear end of the reflective unit 3000 may at least partially overlap with the cut surfaces 2111 and 2121 of the cut lenses 2110 and 2120 in the front-rear direction. Consequently, the space occupied by the vehicle projector 1 in the front-rear direction can be reduced.

In concluding the detailed description, those skilled in the art will appreciate that many variations and modifications can be made to the exemplary embodiments without substantially departing from the principles of the present disclosure. Therefore, the disclosed exemplary embodiments are to be used in a generic and descriptive sense only and not for purposes of limitation.

What is claimed is:

1. A vehicle projector comprising:
a light-emitting unit that emits light for image formation;
an optical unit including at least one optical lens arranged along a reference axis in a path of the light emitted from the light-emitting unit;
a reflective unit that is disposed on a first side with respect to the reference axis and reflects the light emitted from the optical unit in a direction intersecting the reference axis to allow the light to be directed onto a projection surface; and
an optical path adjustment unit that is disposed on a second side with respect to the reference axis and adjusts the path of the light emitted from the optical unit toward the reflective unit.

2. The vehicle projector of claim 1, wherein the reflective unit is disposed across from the projection surface with respect to the reference axis, and
wherein the optical path adjustment unit is disposed in a side closer to the projection surface with respect to the reference axis.

3. The vehicle projector of claim 1, wherein the reference axis is aligned substantially parallel to the projection surface.

4. The vehicle projector of claim 1, wherein the optical unit includes:
a first lens group configured to correct chromatic aberration of the light emitted from the light-emitting unit; and
a second lens group configured to diffuse the light emitted from the light-emitting unit.

5. The vehicle projector of claim 1, wherein the at least one optical lens includes a plurality of optical lenses arranged along the reference axis, and
wherein the plurality of optical lenses include at least one cut lens disposed at a final stage along the path of the light emitted from the light-emitting unit.

6. The vehicle projector of claim 5, wherein each of the plurality of optical lenses includes a first region disposed at a side where the reflective unit is disposed with respect to the reference axis and a second region disposed at a side where the optical path adjustment unit is disposed with respect to the reference axis, and
wherein the at least one cut lens is formed by cutting a portion of the first region.

7. The vehicle projector of claim 6, wherein light incident on the optical unit is emitted through a region disposed at the side where the optical path adjustment unit is disposed with respect to a cut surface of the at least one cut lens.

8. The vehicle projector of claim 6, wherein a region of the light-emitting unit where light is emitted is disposed at the side where the reflective unit is disposed with respect to the reference axis, and
wherein light incident on the optical unit from the light-emitting unit is emitted through the second region of the at least one cut lens.

9. The vehicle projector of claim 5, wherein a rear end of the reflective unit is disposed to at least partially overlap with a cut surface of the at least one cut lens in a front-rear direction.

10. The vehicle projector of claim 5, wherein the optical path adjustment unit is disposed to allow light reflected toward the reflective unit to proceed through a region in front of a cut surface of the at least one cut lens.

11. The vehicle projector of claim 5, wherein the reflective unit and the optical path adjustment unit are disposed to allow light sequentially reflected by the optical path adjustment unit and the reflective unit to proceed through a region in front of a front end of the optical path adjustment unit.

12. The vehicle projector of claim 1, wherein the optical path adjustment unit is inclined such that a rear end thereof is spaced radially farther apart from the reference axis than a front end thereof.

13. The vehicle projector of claim 1, wherein the optical path adjustment unit is disposed such that both of a front end thereof and a rear end thereof are spaced radially apart from the reference axis.

14. The vehicle projector of claim 1, wherein the optical path adjustment unit is inclined with respect to the reference axis by an inclination angle of about 45 degrees.
